(19) United States
(12) Patent Application Publication
(10) Pub. No.: US 2022/0256830 A1
(43) Pub. Date: Aug. 18, 2022

(54) FISHING LINE ALARM

(71) Applicant: Danny H. Hoang, San Jose, CA (US)

(72) Inventor: Danny H. Hoang, San Jose, CA (US)

(21) Appl. No.: 17/177,461

(22) Filed: Feb. 17, 2021

(51) Int. Cl. A01K 97/12

(52) U.S. Cl. CPC A01K 97/125

(57) ABSTRACT

A fishing alarm detector includes a trigger object that has an attachment mechanism that allows the trigger object to be attached to a fishing line. A trigger tube is shaped to receive the trigger object. The trigger tube includes a detector that detects when the trigger object is removed from the trigger tube. The detector is in a “no fish detected” state when the trigger object is within the trigger tube. The detector is in a “fish detected” state when the trigger object is removed from the trigger tube. An alarm mechanism produces an alarm signal indicating a fish has been hooked when the detector is in the “fish detected” state.

### BACKGROUND

There is a recognized need for a fishing line alarm that that provides an alert when a fish is hooked on an unwatched fishing line. Available fishing alarms are triggered, for example, by detection of a bend in a fishing pole or by a sophisticated device that measures line tension.

### BRIEF DESCRIPTION OF THE DRAWINGS

FIG. 1 shows a fishing line alarm that detects the presence of a trigger object within a trigger tube.

FIG. 2 shows a simplified schematic diagram of circuitry within the fishing alarm shown in FIG. 1.

### DETAILED DESCRIPTION

A fishing alarm detector includes a trigger object that has an attachment mechanism that allows the trigger object to be attached to a fishing line. A trigger tube is shaped to receive the trigger object. The trigger tube includes a detector that detects when the trigger object is removed from the trigger tube. The detector is in a “no fish detected” state when the trigger object is within the trigger tube. The detector is in a “fish detected” state when the trigger object is removed from the trigger tube. An alarm mechanism produces an alarm signal indicating a fish has been hooked when the detector is in the “fish detected” state.

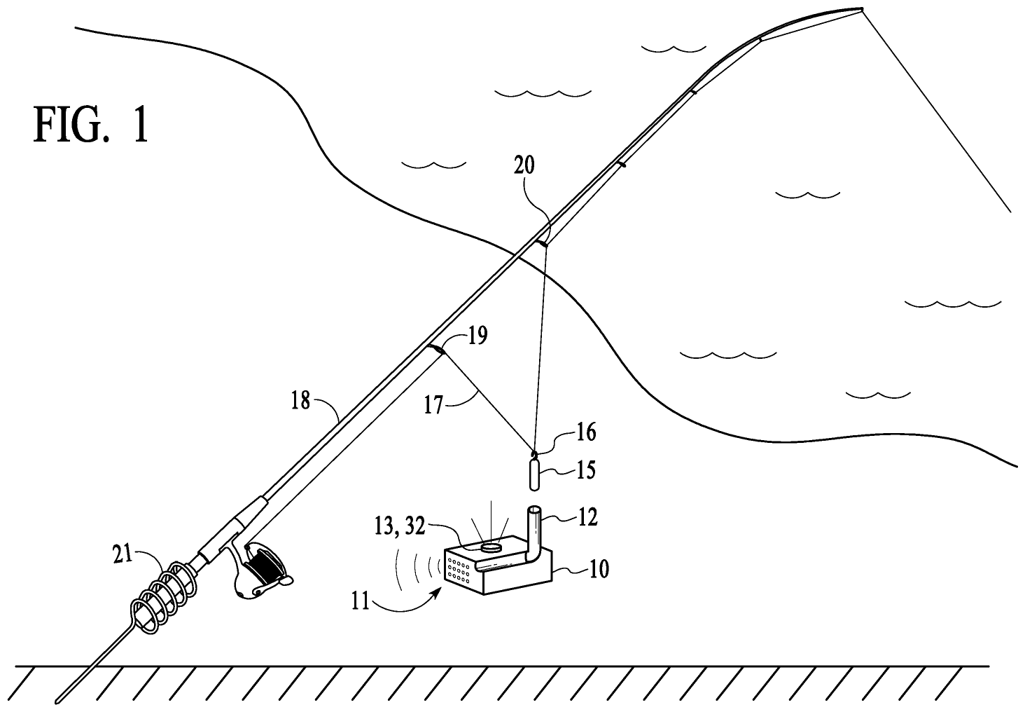

For example, FIG. 1 shows a fishing alarm detector 10 that includes an on/off button 13. A light emitting diode (LED) light 32 indicates when the fishing alarm detector is turned on. For example LED light 32 is incorporated within on/off button 13. A trigger tube 12 accepts a trigger object 15 attached to a fishing line 17. Fishing line 17 extends out from between a guide 19 and a guide 20 of a fishing pole 18.

After a hook and bait are cast out in a body of water, fishing pole 18 is placed, for example, in a rod holder 21 that is planted into the ground using a straight or spiral stake. Fishing alarm detector 10 is situated under fishing pole 18 with an opening of trigger tube 12 facing up toward fishing pole 18 at a location between guide 19 and guide 20. Trigger object 15 is then attached to fishing line 17 using, for example, a hook 16 at a top of trigger object 15. Alternatively, instead of hook 16 another attachment device can be used, such as a hook and loop fastener device, a snap fastener device, a tied fastener device and so on.

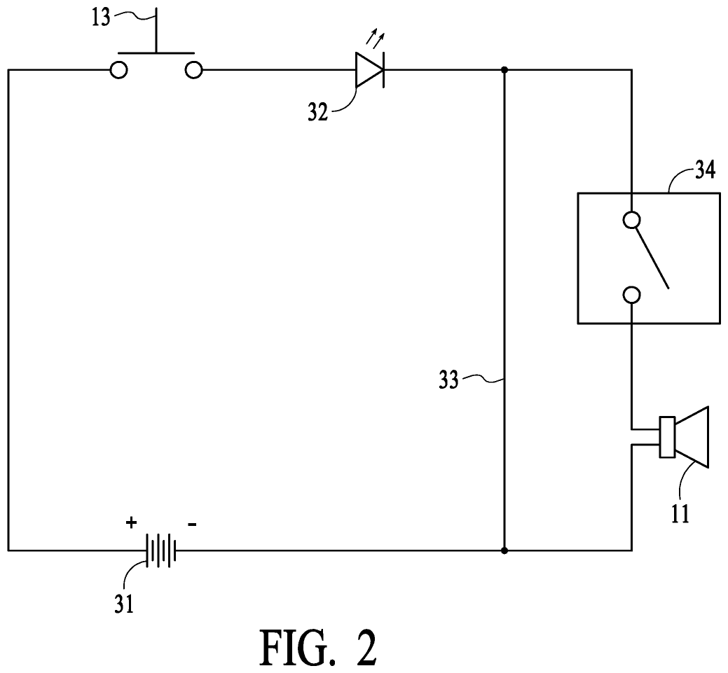

Fishing line 17 is pulled out from between guide 19 and guide 20 as trigger object 15 is lowered into trigger tube 12. On/off button 13 is depressed to activate fishing alarm detector 10. When a fish strikes, fishing line 17 is tightened pulling trigger object 15 out of trigger tube 12. A detector 34 (shown in FIG. 2) within trigger tube 12 detects removal of trigger objection 15 from trigger tube 12 and sounds an alarm to alert that a fish is hooked on fishing line 17. For example the alarm is an audible alarm broadcast on a buzzer 11. Alternatively or in addition, a flashing light can be used as a signal. More complicated signals can also be used. For example, detector 34 can transmit a signal to a cell phone, causing the cell phone to ring or otherwise signal to a user that a fish is hooked on fishing line 17.

FIG. 2 shows a simplified schematic diagram of circuitry within fishing alarm 10. A battery 31 supplied power. An LED 32 is activated and shines when on/off button 13 is in the “on” position. Detector 34 includes a switch that completes a circuit through buzzer 11 when trigger objection 15 is removed from trigger tube 12.

For example when not in use, trigger tube 12 folds down into a storage position at a side of fishing alarm detector 10, as indicated by an arrow 13. This also positioning of trigger tube 12 when fishing alarm detector is placed on an uneven surface.

For example, on/off button 13 can be implemented or replaced by another type of on/off switch mechanisms such as a slide switch, a toggle switch, a rotary switch, a rocker switch or a knife switch.

For example, buzzer 11 can be implemented or replaced using piezoelectric element, an electromechanical device such as an electric bell, a joy buzzer, a ringer and so on. A sound generated can be a click, a ring, a beep, a combination of tones and so on.

Trigger object 15 can be implemented, for example, from metal, plastic or a combination of materials. For example, a weight for trigger object 15 is selected to limit false alarms. For example, the weight for trigger object 15 should be light enough so that a fish tugging on fishing line 17 will pull trigger object 51 out of trigger tube 12. However, the weight for trigger object 15 should be heavy enough so that when there is not fish tugging on fishing line 17 trigger object 51 will remain in trigger tube 12. For example, multiple differently weighted trigger objects may be provided for a single fishing alarm detector 10. For applications where a targeted game fish is smaller and fish tackle is lighter, a lighter weight for trigger object 15 may be selected. On the other hand, for applications where a targeted game fish is larger and fish tackle is heavier, a heavier weight for trigger object 15 may be selected.

Detector 34 is implemented, for example, by using a spring activated switch on which trigger object 15 rests. Which trigger object 15 rests against a lever of the spring activated switch, trigger object 15 pushes the lever down so that the switch is in the off position. When trigger object 15 is removed from the lever of the spring activated switch, a spring pushes the lever up so that the switch is in the on position.

Alternatively, detector 34 is implemented, for example, by using an optical detector. When trigger object 15 is within trigger tube 12, trigger object 15 blocks an optical beam or another type of light so that a switch inside detector 34 is in the off position. When trigger object 15 is removed from trigger tube 12, the optical detector detects light from the optical beam or light from another source so that that the switch is in the on position.

Alternatively, detector 34 is implemented, for example, by using a magnetic field detector. When trigger object 15 is within trigger tube 12, trigger object 15 interferes with a magnetic field so that a switch inside detector 34 is in the off position. When trigger object 15 is removed from trigger tube 12, trigger object no longer interferes with the magnetic field so that the switch is in the on position. For example, trigger object 15 is a magnet and detector 34 detects a magnetic field change when trigger object I within trigger tube 12.

Alternatively, another type of technology may be used to implement detector 34 provided that when trigger object 15 is within trigger tube 12, a switch inside detector 34 is in the off position and when trigger object 15 is removed from trigger tube 12 the switch is in the on position.

Alternatively, detector 34 is implemented, for example, by using a magnetic field detector. When trigger object 15 is within trigger tube 12, trigger object 15 interferes with a magnetic field so that a switch inside detector 34 is in the off position. When trigger object 15 is removed from trigger tube 12, trigger object no longer interferes with the magnetic field so that the switch is in the on position.

For example, trigger object 15 is encased in glow-in-the-dark plastic of a bright color, such as orange or pink. This facilitates finding trigger object 15 if during the excitement of catching a fish, rigger object 15 is dropped when removing trigger object 15 from the fishing line. The “glow-in-the-dark” is a help in finding trigger object 15 if dropped at night, and the bright colors, such as orange or pink, enhances the likelihood trigger object 15 will be easily seen an recognized if dropped during daylight.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A fishing alarm detector, comprising:
a trigger object having an attachment mechanism that allows the trigger object to be attached to a fishing line;
a trigger tube shaped to receive the trigger object, the trigger tube including:
a detector that detects when the trigger object is removed from the trigger tube, the detector being in a “no fish detected” state when the trigger object is within the trigger tube and the detector being in a “fish detected” state when the trigger object is removed from the trigger tube;
an alarm mechanism that produces an alarm signal indicating a fish has been hooked when the detector is in the “fish detected” state.

2. A fishing alarm detector as in claim 1, wherein the attachment mechanism is a hook.

3. A fishing alarm detector as in claim 1, wherein the detector includes a spring activated switch on which the trigger object rests.

4. A fishing alarm detector as in claim 1, wherein the detector includes an optical detector.

5. A fishing alarm detector as in claim 1, wherein the detector includes a magnetic field detector.

6. A fishing alarm detector as in claim 1, wherein the alarm mechanism produces and audio signal to signal a fish has been hooked.

7. A fishing alarm detector as in claim 1, wherein the alarm mechanism produces a flashing signal to indicate a fish has been hooked.

8. A fishing alarm detector as in claim 1 additionally comprising a push button on-off switch.

9. A fishing alarm detector as in claim 1 additionally comprising a push button on-off switch with an integrated LED light.

10. A method of fishing using an unwatched fishing pole;
attaching a trigger object to a fishing line of a fishing pole;
anchoring the fishing pole; and
lowering the trigger object into a trigger tube of a fishing alarm detector, the fishing alarm detector performing the following:
being an in a “no fish detected” state when the trigger object is within the trigger tube,
detecting when the trigger object is removed from within the trigger tube,
being in a “fish detected” state when the trigger object is removed from the trigger tube, and
producing an alarm signal indicating a fish has been hooked when the detector is in the “fish detected” state.

11. A method as in claim 10, wherein the trigger object is attached to the fishing line sing a hook integrated as part of the trigger object.

12. A method as in claim 10, wherein the fishing alarm detector detects when the trigger object is removed from within the trigger tube using a spring activated switch on which the trigger object rests.

13. A method as in claim 10, wherein the fishing alarm detector detects when the trigger object is removed from within the trigger tube using an optical detector.

14. A method as in claim 10, wherein the fishing alarm detector detects when the trigger object is removed from within the trigger tube using a magnetic field detector.

15. A method as in claim 10, wherein the alarm signal is an audio signal to signal a fish has been hooked.

16. A method as in claim 10, wherein the alarm signal is a flashing signal to indicate a fish has been hooked.

17. A method as in claim 10 additionally comprising:
removing the rigger object from the fishing line; and
reeling in the fishing line.
